(19) United States
(12) Patent Application Publication
(10) Pub. No.: US 2023/0138070 A1
(43) Pub. Date: May 4, 2023

(54) Method and Apparatus to Generate Measurements for and Manufacture a Conformal Fitting Cap

(71) Applicant: Michael L. Zumbrunnen, Rochester, MN (US)

(72) Inventor: Michael L. Zumbrunnen, Rochester, MN (US)

(21) Appl. No.: 17/979,263

(22) Filed: Nov. 2, 2022

Related U.S. Application Data
(60) Provisional application No. 63/275,566, filed on Nov. 4, 2021.

(51) Int. Cl. G01B 11/08; G01B 11/00; A42B 1/22

(52) U.S. Cl. CPC G01B 11/08; G01B 11/002; A42B 1/22

(57) ABSTRACT

A method and apparatus to obtain very accurate measurements of the perimeter of a person's head scanning with an optical device; transmitting the scanned data to one or more processors which translate the measurements as precise three-dimensional data wherein an x-y plane is defined as the beginning or lower edge of the conformal cap from which a z-axis extends orthogonally in a upwardly direction towards the crown of a person's head. The three-dimensional data may be further processed to a suitable format for transmission to a transformation tool that moves one or more actuators to create an accurate three-dimensional mold of the person's head, upon which fabric or foam can be applied to create an accurate conformal cap for subsequent uses.

### BACKGROUND

Sizes of human heads generally vary by gender and age with males have nominally larger heads than females, and adults having larger heads than children. Within each grouping, moreover, there is a large distribution in size—one size does not fit all. One's head circumference is generally accepted as a metric of head size but anthropometric head survey data indicates the circumference of adult heads ranges from 50 to 63 centimeters and the unique shape of each human head cannot be discerned by circumference alone. Thus, many other measurements along other dimensions define one's head size and shape.

Head gear matching a particular head size and shape is important for medical applications especially when the head gear incorporates instrumentation, thermal control, or stabilization. Even a small mismatch may degrade the functional effectiveness of the head gear. These applications include treating brain trauma, treating alopecia induced by chemotherapy, immobilizing the head during and/or after surgery, suppressing the effects of concussion, and other uses. Non-medical applications include head gear for electroencephalograms (EEG) or other brain activity sensors, such as those that may interpret sleep activity or intent of the wearer for controlling external devices, e.g., automobiles, electronic games, or virtual reality simulators, etc. When used medically, it may be preferable that conformal head gear be immediately available or very shortly after the need for it arises in order for the medical treatment is to be effective. For example, to cool the scalp for treating alopecia induced by chemotherapy, the patient may have only a few days from cancer diagnosis until treatment. During that time, the patient may need to accept the diagnosis, research treatments, make decisions, and order and receive a cooling cap, all of which can be stressful. For brain trauma and depending on its severity, the patient may be discharged within days of the injury with a portable hypothermia device with a cooling cap for on-going treatments, such as described in U.S. Pat. No. 10,806,626 B2 issued 20 Oct. 2020 entitled Method and Apparatus of a Self-Managed Portable Hypothermia System to Zumbrunnen et al. and U.S. patent application Ser. No. 17/019,301 filed 13 Sep. 2020, U.S. Patent Application Publication No. US 202110022915 A1, published 28 Jan. 2021 entitled Method and Apparatus of a Self-Managed Portable Hypothermia System to Zumbrunnen et al., all of which are herein incorporated by reference in their entirely.

### DESCRIPTION OF THE DRAWINGS

FIGS. 1A and 1B are depictions of apparati that may be used to scan a person's head.

FIG. 1C represents the scanned measurement data.

FIG. 2 describes a method to obtain scanned measurement data of a person's head.

FIG. 3 is a view of a processing system in communication with a transformable tool and a 3-D printer by which a conformal cap can be manufactured.

FIG. 4 describes a method to transform the scanned measurement data to a useable format.

FIG. 5 illustrates the isometric illustration of transformed data set.

FIGS. 6 and 7 are a plan view and an isometric view, respectively, of the transformable too.

FIG. 8A is an enlarged view of a perimeter actuators. FIG. 8B is an enlarged view an interior actuator.

FIG. 9 is an enlarged isometric view of the perimeter actuators and interior actuators of the transformable mold.

FIG. 10 describes a method to set up a transformable tool and manufacture a conformable cap.

FIG. 11 illustrates a fabric cap placed over a transformable mold.

FIG. 12 illustrates an embodiment of a conformal cap wrapped in tubing.

FIG. 13 illustrates an embodiment of applying foam to make a conformal cap with the transformable mold

The preceding FIGS. are best viewed in conjunction with the following description.

### SPECIFICATION

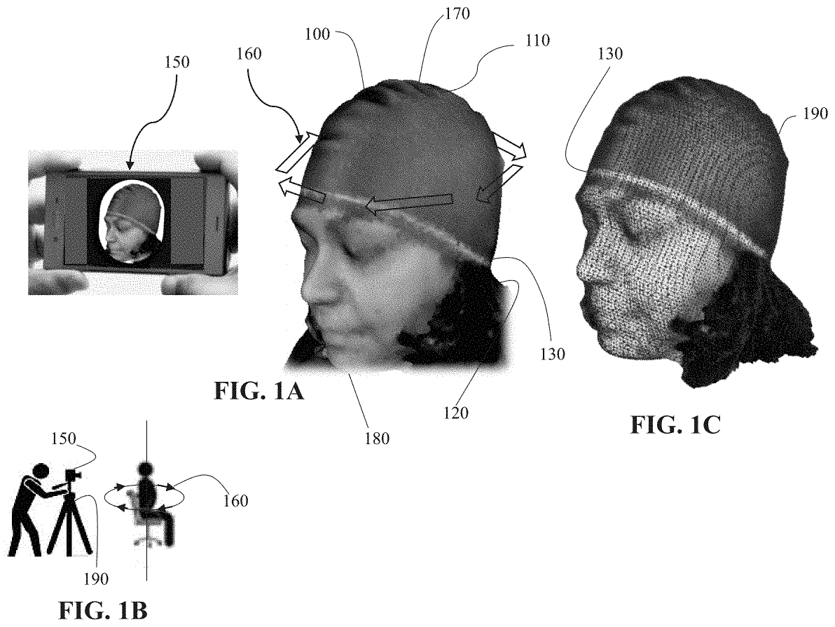

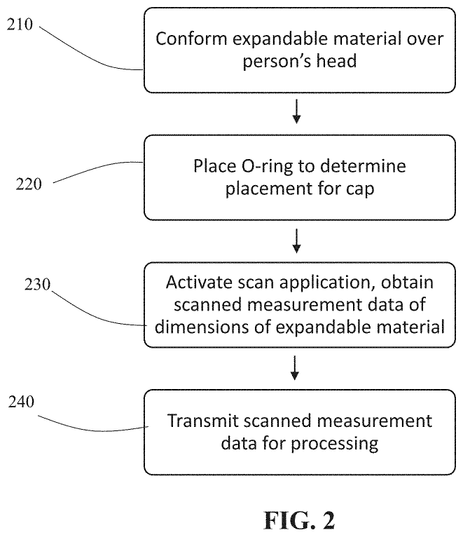

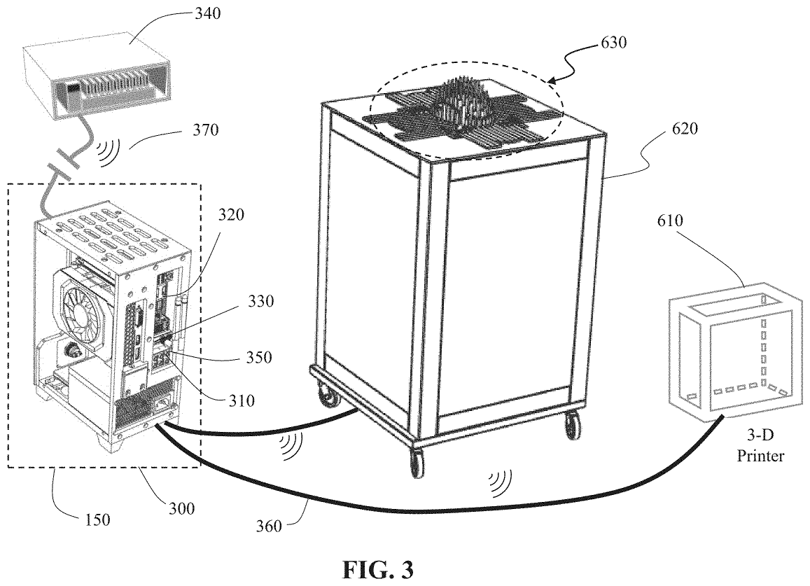

In accordance with the disclosure herein, FIG. 1A illustrates a person's head 100. An expandable yet tight-fitting material 110 is placed on the person's head 100. Preferably, the expandable tight-fitting material 110 may be thin rubber, silicone, or other biocompatible material. The person's hair 120 is compressed against the skull and trapped in as thin a layer as possible between the skull and the expandable tight-fitting material 110. Given the variability of head sizes possible, the expandable tight-fitting material 110 may be stretched in different tensions and different dimensions for each individual in order to cover all or part of the ears and forehead once snugly situated, this step is shown as block 210 in FIG. 2. To distinguish where the end (beginning) of the custom to-be-made conformal cap should be situated relative to other head features such as forehead, eyes, ears, etc., an O-ring 130 stretchable from 400 to 800 centimeters in diameter is situated over the expandable tight-fitting material 110 at a location where the end (beginning) of the conformal to-be-made cap is desired, as indicated as block 220 of FIG. 2. The expandable tight-fitting material 110, once snugly situated on the person's head 100, represents the interior surface of the to-be-made custom cap. It is preferable that O-ring 130 be of a different color, texture, or otherwise distinctive than the expandable tight-fitting material 110 so that it can be distinguished easily, as will be described herein.

An activated scanning device 150 is orbited 360 degrees around the person's head 100 as indicated by arrows 160. The scanning device 150 captures scanned measurement data 190 of approximately 30,000 x, y, z data points, as shown in FIG. 1C, representing the physical coordinates of the outside surface of the person's head 100.

Alternatively, as illustrated in FIG. 1B, the scanner 150 can be stationary 190 and the person, donned with the expandable material 110 and the O-ring 130 can rotate 360 degrees within the aperture of the scanning device 150, as indicated by arrows 160. In either case, a complete scanned measurement data 190 representing the surface of a person's head 100 is captured by the scanning device 150 in block 230. The scanning device 150 preferably is accurate to one millimeter or less, and is able to discern variations in color, texture or other contrasts. The scanning device 150 may be a hand-held mobile device having a light detection and ranging (LIDAR) sensor, a camera, a laser scanning sensor, or a sensitive smart phone camera such as an iPhone TrueDepth™ camera.

With reference to FIG. 1A, the direction from the O-ring 130 towards the crown 170 of the head 100 will be deemed to be up or above. The direction from O-ring 130 towards the chin 180 and shoulder will be deemed to be down or below. The direction from the expandable material 110 and O-ring 130 towards the interior of the person's head 100 will be deemed to be inside, inner, or interior. The direction from the expandable material 110 and O-ring 130 away from the person's head 110 will be deemed to be outside, outer, or exterior.

The scanned measurement data 190 are exported from the scanning device 150 in OBJ, PLY, JPEG or similar industry standard file format capable of translating to x, y, z coordinates for additional processing, as in block 240 of FIG. 2. The ability to ascertain contrast variability allows discernment of data points corresponding to the position of the O-ring 130 relative to the entire scanned measurement data. Under ideal circumstances with a cooperative person and an experienced other person operating the scanner, the entire process may require five minutes or less which may involve donning the expandable material 110 on the person's head 100, situating the O-ring 130, obtaining the scanned measurement data 190 representing the coordinates of the expandable material 110 on the person's head 100, and transmitting the scanned measurement data 190 for subsequent analysis.

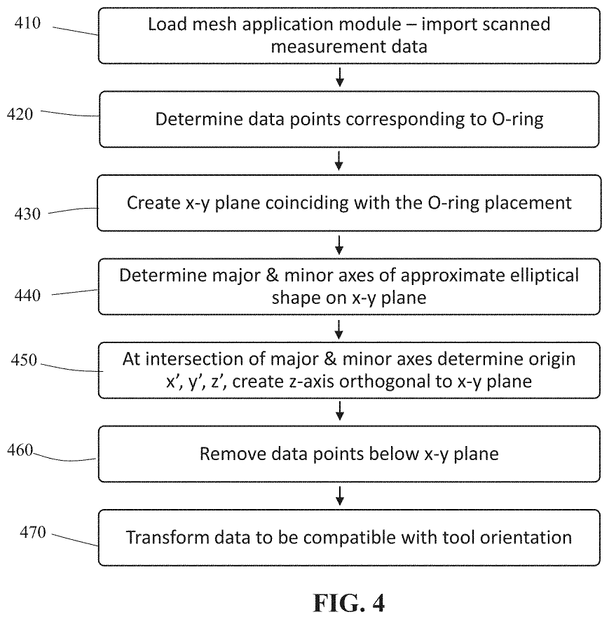

As mentioned and shown in block 240 of FIG. 2, the tens of thousands data points of the scanned measurement data 190 shown in FIG. 1C correlate to the x, y, z physical coordinates of the expandable material 110 on the person's head 100. The scanned measurement data 190 are transmitted to a processor system 300 to be processed by a mesh manipulation module 310, as shown in FIG. 3. The mesh manipulation module 310 may be stored in a memory 320 associated with the processor system 300 or may be downloaded into the processor system 300 from a remote server 340 or may be embodied as firmware within or connected to processor system 300. It is further within the purview of this description that the mesh manipulation module 310 may be executing in a processing system 300 within the scanning device 150 itself or may be transmitted to a remote processing system 340. It is further considered herein that processing system 300 may be contained with the transformable mold tool 620 and/or a 3-D printer. It is further within the purview of this description that the scanned measurement data 190 may be transmitted to processing system 300 via wired 360 or wireless 370 connections.

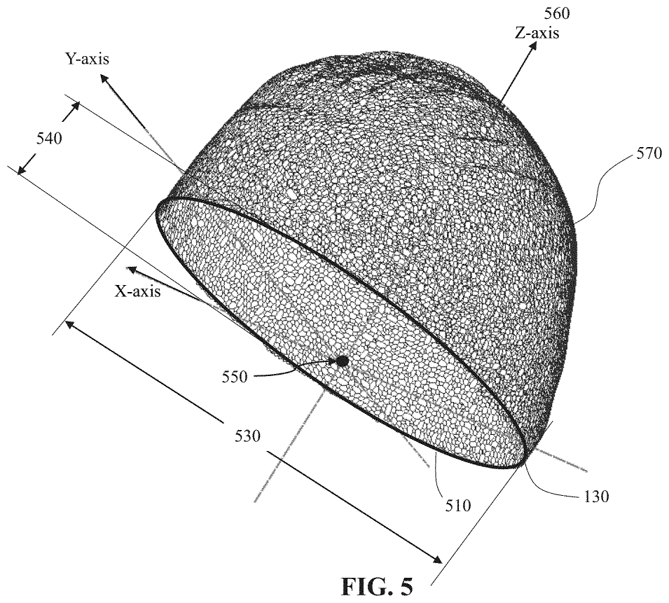

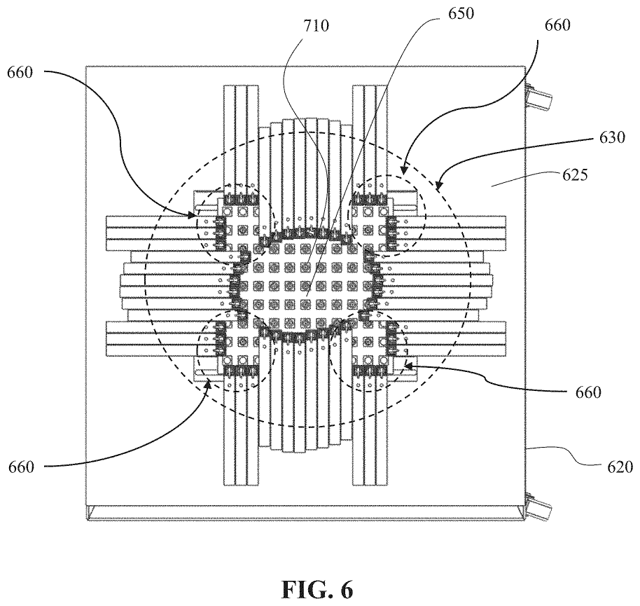

Viewing FIGS. 4 and 5 together, in block 410, the scanned measurement data 190 is input into the processing system 300 executing a mesh manipulation module 310. In block 420, the mesh manipulation module 310 determines which data points of the scanned measurement data 190 correspond to the location of the O-ring 130 because of its contrasting color, texture, or other distinguishing attribute. Using the location of the circumscribed O-ring 130, step 430 creates a plane 510 having x-y axes coincident with the plane of the O-ring 130. In step 440, the mesh manipulation module 310 determines a major axis 530 and a minor axis 540 on the x-y plane 510 of an elliptical-like shape determined by the scanned measurement data 190 inside the O-ring 130. Point 550 is the intersection of the x- and y-axes and will be considered x′ and y′. One of skill in the art will appreciate that the scanned measurement data 190 of the O-ring 130 will not be a perfect ellipse because of variations of the individual heads. In step 450, at the intersection of the major axis 530 and the minor axis 540, a z-axis 560 and its origin z′ are determined so that the z-axis 560 extends orthogonally from the x-y plane 510 up towards the crown 170 of the person's head 100 to create a surface 570 bounded by the scanned measurement data 190 above the O-ring 130. In step 460, the scanned measurement data 190 below the x-y plane 510 and outside or exterior to the O-ring 130 are removed from the measurement data and are not involved in the further processing. In step 470, the retained scanned measurement data 190 are transformed to orient the surface 570 consistent with a physical tool implementation (described below) such that the transformed measurement data 570 has an origin 550, i.e., x″, y″, z″, located in x and y directions on the x-y plane 510 extending upward along a z-axis 560.

The transformed measurement data 570 describes the inside surface of a conformal cap corresponding to the outside surface of a person's head 100. The transformed measurement data 570 is input into a conformal cap design module located in processor system 300 for creating additional conformal cap features beyond the inside surface of the conformal cap. The transformed measurement data 570 and the additional conformal cap design features are transmitted to a transformable tool 620 or to a 3-D printing tool 610 for conformal cap fabrication.

With reference to FIGS. 3, 6, 7, and 8, the transformed measurement data 570 is input into a transformable tool 620 comprising a transformable mold 630. Transformable mold 630 comprises a plurality of actuators 710 and actuator assemblies 810, both of which can be articulated independently as described herein to create a surrogate head form matching in size and shape to the transformed measurement data.

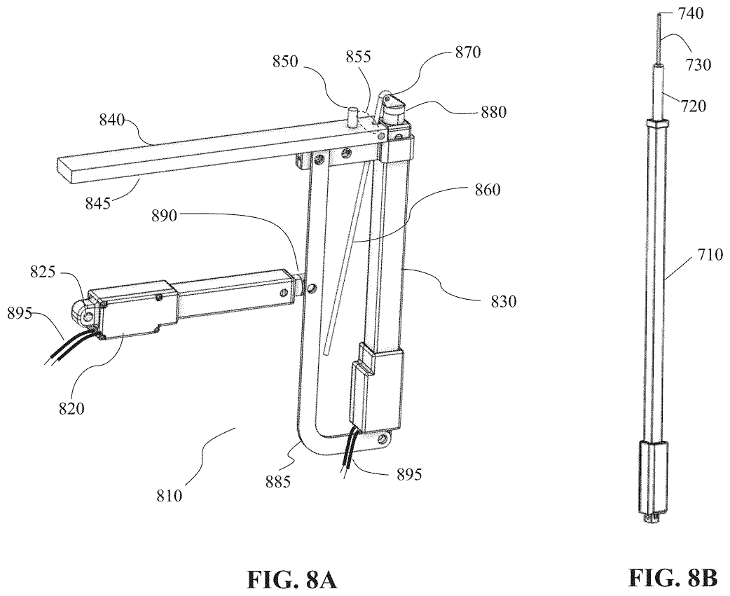

FIGS. 8A and 8B illustrate the structure of the actuator assemblies 810 and actuators 710. Shown in FIG. 8A, actuator assemblies 810 comprise a first perimeter actuator 820 and a second perimeter actuator 830. First perimeter actuator 820 comprises a horizontal solenoid/cylinder 890 for x- or y-directional movement depending on its location within the transformable mold 630. A second perimeter actuator 830 comprises a vertical solenoid/cylinder 880 for z-directional movement. The perimeter actuator assemblies 810 define the lowest perimeter of the cap to be made at location set by O-ring 130 in the x-y plane 510. The perimeter actuator assemblies 810 comprise base 840, a post 850 rising from the base, rod 860, power and control connections 895, and mechanical hardware 885 to structurally maintain the actuators 820, 830. The base 840 is flat or contoured at location z″ 855 to capture the first (last) conduit of the cap that may be placed between post 850 and rod 860. Cylinder 880 is located as close to post 850 as the implementing cylinder technology will allow. Close proximity between cylinder 880 and post 850 is important because the head size typically changes size rapidly away from the z-plane at the perimeter location. Rod 860 emanates from the z″ location as perimeter actuator 830 extends or retracts cylinder 880 at location 870.

FIG. 8B shows the structure of interior actuator 710 comprising a movable cylinder 720 from which a portion is of smaller diameter 730, preferably two millimeters or less at tip 740. Rod 720 extends along the z-direction to define the height of the interior dimensions of the conformal cap to be manufactured. Tips 870 of actuator assemblies 810 and tips 740 of actuator 710 are smooth and rounded to prevent damage to the soon-to-be formed cap resting on top

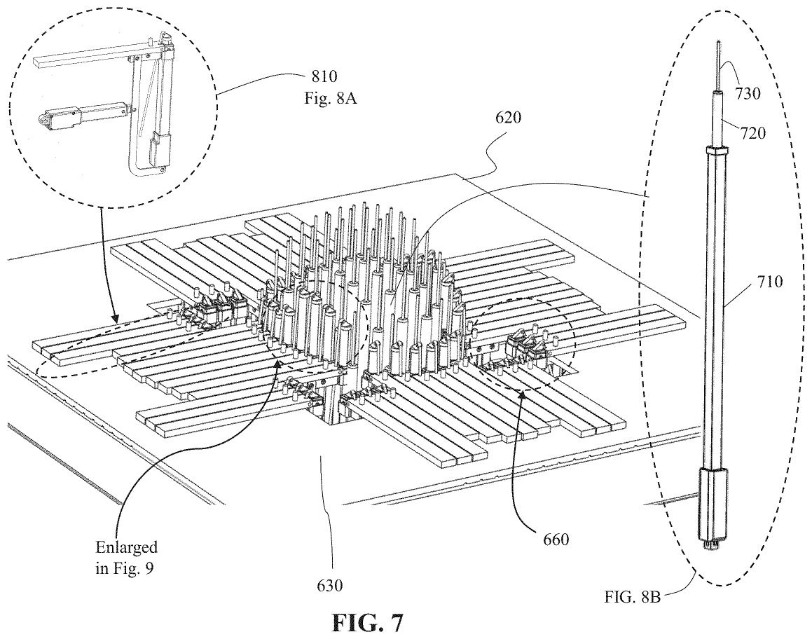

FIG. 6 shows a plan view of the transformable tool 620. Ideally, a single transformable tool 620 accommodates the smallest to the largest head sizes as documented in anatomical databases. The number of actuators 710 and actuator assemblies 810 is determined by the desired accuracy of the surrogate head but may be also limited by the physical size of the actuators 710, 820, 830 within the transformable tool 620. Thus, the relative position of the actuators 710, 820, 830 to each other are determined by the transformable tool's 620 physical implementation. In one embodiment, the transformable tool 620 may have up to three hundred actuators 710, 820, 830 to set the x-y-z locations of the transformable mold 630. The minimum actuator periodicity, based on current commercially available state-of-the-art actuators, is eighteen millimeters, but this dimension is not intended to be limiting. Pneumatic, electrical, mechanical, and even piezoelectric movement actuators on the order of micrometers or even nanometers are to be considered within the purview of this disclosure. In one embodiment with regard to physical constraints and desired accuracy, the transformable mold 630 has two hundred three (203) actuators 710, 820, 830 of which ninety-nine are interior actuators 710 and are fixed in an array 650 with its center at x′, y′, z′. The perimeter actuator assemblies 810 are distributed around the perimeter of the transformable tool 620 with a portion indicated as 820 dedicated to x- and y-movement, and a portion indicated as 830 allocated to movement along the z-direction. In one example of specific transformed data but not to be limiting, fifty-two perimeter actuator assemblies 810 defines the location set by O-ring 130 in the x-y plane 510 on the transformable mold 630. Each actuator assembly 810 is located within transformable tool 620 by fastening actuator 830 using mounting hole 825 to a fixed location within tool (not shown) and retaining the bottom surface 845 of base 840 as channels located in surface 625

Ideally, a single tool 620 accommodates the smallest to the largest head sizes as documented in anatomical databases. Depending on head size, some interior actuators 710 and some perimeter actuator assemblies 810 will not be used because they are outside the perimeter of the transformed measurement data 570. For example, for a medium head size, actuators in the areas 660 are moved to a position away from use so as to not interfere with other actuators in the final transformable mold 630. FIG. 7 illustrates an embodiment of the transformable tool 620 with more detail of the transformable mold 630 having a plurality of perimeter actuator assemblies 810 and an array of interior actuators 710 at locations extending above the x-y plane 510 to correspond to the transformed measurement data 570 or at retracted locations 660.

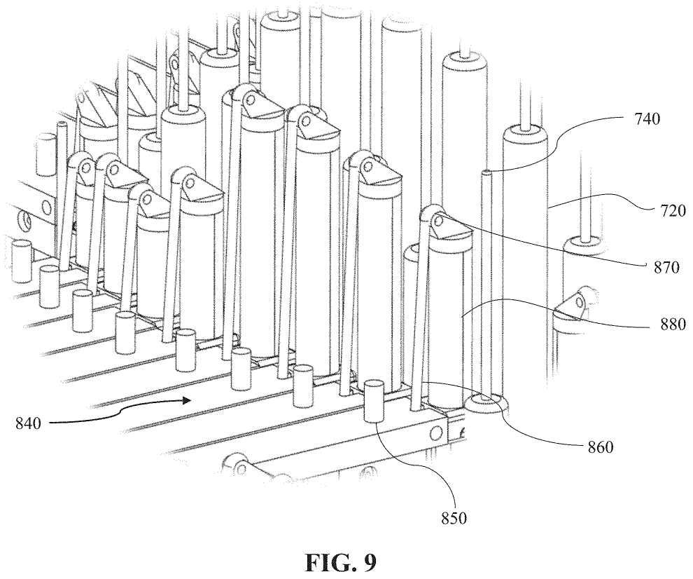

FIG. 9 is an enlargement of the region indicated in FIG. 7 and illustrates rods 860 extending beyond base 840 to tip 870 for multiple perimeter actuator assemblies 810. Each show their tip 870 located to a z-height to match the transformed data at that location. Once the perimeter actuator assemblies 810 and interior actuators 710 have their cylinders moved to their appropriate locations, cylinder tips 870 of actuator 830 and tips 740 of actuators 710 are extended to represent points on a surrogate head of the original head size and shape.

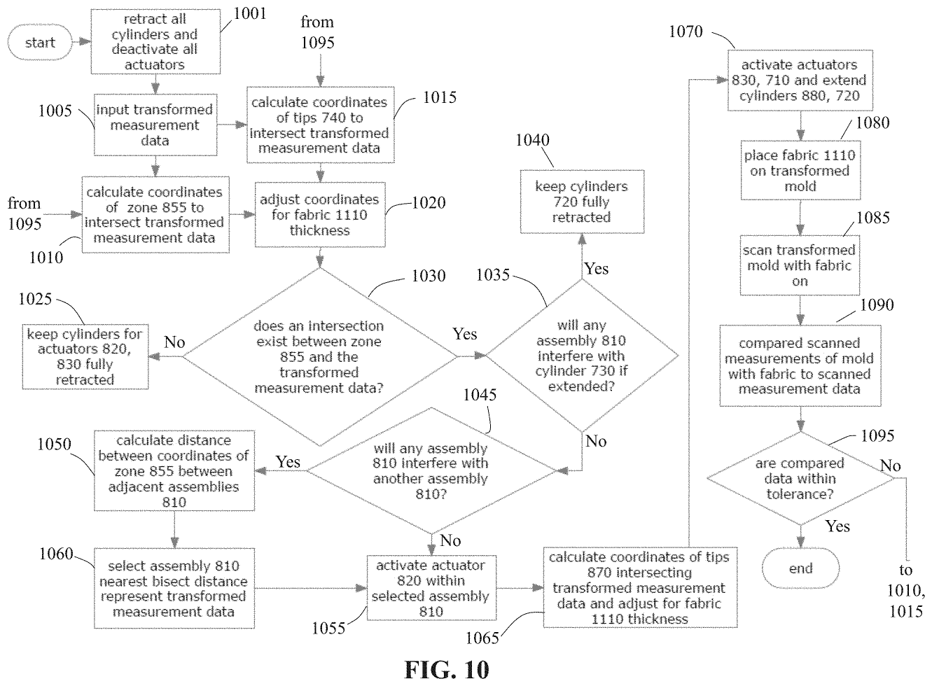

FIG. 10 represents the method by which to manipulate the actuators 710, 820, 830 in the transformable mold 630 to achieve a mold for manufacturing a conformal cap. In block 1001, prior to executing a transformation, cylinders 720, 880, 890 are fully retracted in actuators 710, 830, 820 respectively and the actuators are deactivated. In block 1005, the transformed measurement data 570 from block 470 of FIG. 4 is input to a transformation module 350. Transformation module 350 may be embedded as firmware in the transformation tool 620, 3-D printer 610, or stored and executing in a local or remote processing system 300, 340 in communication with the transformation tool 620 or a 3-D printer 610.

In block 1010, the transformation module 350 determines the coordinates x-y coordinates of the center of zone 855 for each perimeter actuator assembly 810 intersecting with data points that are coincident with the plane of the O-ring 130 of the transformed measurements. In block 1015, the transformation module 350 determines the z coordinate of tips 740 intersecting with data points coincident with surface 570. In block 1020, the aforementioned coordinates of tips 740 of actuators 710 may be adjusted to accommodate the thickness of any fabric, foam, and/or other material 1110 that will become the transformable mold surface upon which the conformal cap will be made. For those perimeter actuator assemblies 810 where an intersection between the coordinates of zone 855 and the transformed measurements does not exist, in block 1025, the perimeter actuators 820 keep fully retracted their respective cylinders 890 and perimeter actuators 830 keep fully retract their respective cylinders 880, as shown at locations 660 of FIG. 6.

For some head sizes, multiple perimeter actuator assemblies 810 may have calculated coordinates that intersect the transformed measurement data 570 but interfere with each other or with the centrally located actuators 710 if cylinders 720 were extended. For these cases, blocks 1035, 1045, the interfering cylinders 720 are kept retracted, block 1040 and the perimeter actuator assemblies 810 having coordinates that best bisect the distance between adjacent actuator assemblies 810, block 1050, are retained as in block 1060 and any remaining interfering perimeter actuator assemblies 810 have their cylinders 880, 890 fully retracted, block 1025.

In block 1055, transformation module 330 activates control signals to move perimeter actuators 820 of the transformable mold 630 to the x-y positions that correspond to the transformed measurement data 570 of the O-ring 130 and to the “best-fit” positions determined in step 1060. In block 1065, the transformation module 350 determines the z coordinate of tips 870 intersecting with data points coincident with surface 570 with adjustments accommodating material thickness 1110 if implemented. In block 1070, the cylinders 880 and rods 860 of perimeter actuators 830 are extended to establish the z-profile of the perimeter. Also, In block 1070, the interior actuators 710 are activated within the interior space circumscribed by the perimeter established in blocks 1055.

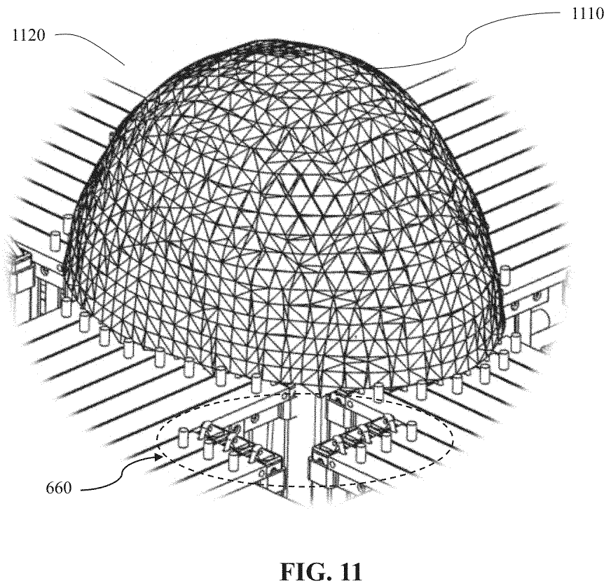

In block 1080, a thin, conformable durable fabric 1110, such as outer wear clothing material is placed on the transformable mold 630, block 1080, having correctly positioned actuator tips 740, 870 and as shown in FIG. 11. The movable rods 860 of the actuators 830 attached to cylinder 880 represents its tip 870. Tips 870 and tips 740 of cylinder 730 are smooth and rounded to prevent damage the soon-to-be formed cap resting on top of the transformable mold 630. Preferably, as in block 1085, after the fabric 1110 or foam 1310 is positioned on the transformable mold 630, the covered transformable mold 1120 is scanned robotically or by the method of block 240 of FIG. 2. As in block 1090, the newly scanned data measurements taken on the actual x-y-z coordinates implemented in the transformable mold 630 are compared to calculated locations of steps 1010, 1015 for quality control purposes. Comparative analysis of scanned tool data to original scanned measurement data 190, as in blocks 1095, may suggest iteratively repeating the tool's actuator positioning functions from blocks 1010, 1015 until the resulting transformable mold 630 is within acceptable tolerances, such as two millimeters or less.

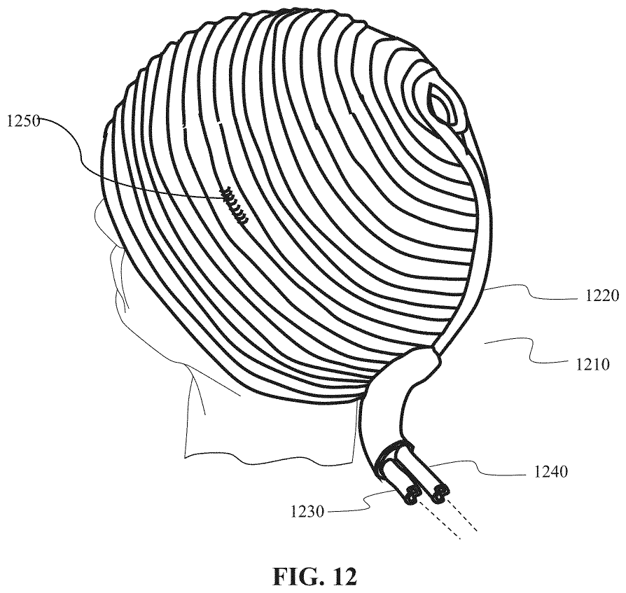

For selective thermal treatment of the head, the conformal cap created as described herein may be used to create head gear 1210 as in FIG. 12. To manufacture head gear 1210, a single continuous flexible and thermally conductive coolant tube 1220, 13-18 meters in length, is wrapped tightly around the transformable mold 630 covered with fabric 1110 or foam 1310 starting at the z′ plane and wrapped contiguously towards the crown in the z-direction until the minimum recommended radius of the tube 1220 is reach, such as described in U.S. Pat. No. 10,806,626 B2 issued 20 Oct. 2020 entitled Method and Apparatus of a Self-Managed Portable Hypothermia System to Zumbrunnen et al. and U.S. patent application Ser. No. 17/019,301 filed 13 Sep. 2020, U.S. Patent Application Publication No. US 202110022915 A1, published 28 Jan. 2021 entitled Method and Apparatus of a Self-Managed Portable Hypothermia System to Zumbrunnen et al., herein incorporated by reference in their entirely. On each end is an appropriate length of tube 1220 extends beyond the head gear 1210 for connection to a separate device that provides fluid to be pumped through the tubing 1220. A coolant passes through the tube 1220 from inlet 1230 to outlet 1240 and the cap's hypothermia effectiveness is directly related to how well it contacts the flattened hair layer caused by the conformal cap. The flexible tube material 1220 allows for some additional conformity to the head shape beyond that generated by the transformative mold 630 and also provides a degree of comfort to the wearer. The wrapping process may take less than fifteen minutes under ideal circumstances.

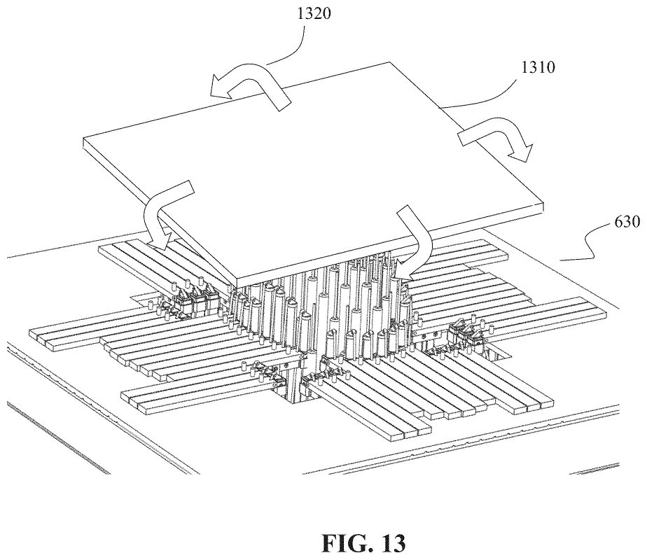

FIG. 13 illustrates the use of the transformable mold 630 to create a custom padded helmets or other head covering. Approximately 0.1-0.3 square meters of high impact absorbing foam 1310 is formed 1320 over the transformed mold 630 from the top downward. At z=0 location any excess foam is cut off with a knife or razor blade.

At locations determined by the application for the custom cap, sensors or housings may be located either between conduits or through the absorbing foam. For example, multiple thermal sensors can be located for scalp temperature sensing, or microwave radiometers can be located for brain temperatures, or EEG sensors can be located for brain electrical activity. Once the tubes are wrapped or the foamed formed and sensors installed, an adhesive 1250 is applied over the outside of the tubes (shown in FIG. 12 at only one location for clarity). The adhesive can be applied at only selective locations for additional flexible properties if desired. Ideally, the durometer of the cured adhesive is low enough to not inhibit the flexible characteristics of the conduit or foam. About one hour after starting the adhesive application and before full cure of the adhesive, the cap can be removed from the tool if desired. Once removed, the fabric cap may be reserved for future use and the cylinders can be repositioned for making the next custom cap.

Several embodiments and variations of the invention have been described above. One of ordinary skill in the art will appreciate and understand the depth and breadth of the description above. The invention, however, is set forth in the following claims.

What is claimed is:

1. A method to create a conformable fitting cap, comprising:
placing a snug expandable material on a person's head;
defining a beginning edge of the conformable fitting cap on the person's head;
orienting a scanning device to scan a perimeter of the person's head;
using the scanning device, obtain scanned measurement data of the perimeter of the person's head;
transmitting the scanned measurement data to one or more processors;
the one or more processors translating the scanned measurement data to three-dimensional coordinates for further processing;
the one or more processors determining an x,y plane corresponding to the beginning edge of the conformable fitting cap;
the one or more processors determining a z-axis orthogonal to the x,y plane;
the one or more processors culling the translated scanned measurement data below the x,y plane;
the one or more processors converting remaining scanned measurement data at and above the x,y plane to a format of a transformation tool;
transmitting the converted remaining scanned measurement data to the transformation tool;
from the converted remaining scanned measurement data, the transformation tool generating a mold representing an outer surface of the person's head;
applying a fabric or foam onto the mold to create the conformable fitting cap.
